(19) United States
(12) Patent Application Publication
(10) Pub. No.: US 2026/0320194 A1
(43) Pub. Date: Oct. 15, 2026

(54) INTELLIGENT VULNERABILITY ANALYSIS AND REMEDIATION (iVar) SYSTEM

(71) Applicant: JPMorgan Chase Bank, N.A., NEW YORK, NY (US)

(72) Inventors: Mu Chai, Bellevue, WA (US); Bohdan Velushchak, Woodinville, WA (US); Xin Yu, Erskine (GB); Karthikeyan Mahalingampandian, Plano, TX (US); Sheri R. Hiller, Colts Neck, NJ (US)

(73) Assignee: JPMorgan Chase Bank, N.A., NEW YORK, NY (US)

(21) Appl. No.: 19/178,654

(22) Filed: Apr. 14, 2025

(51) Int. Cl. G06F 21/57; G06F 8/35; G06F 21/54

(52) U.S. Cl. CPC G06F 21/577; G06F 8/35; G06F 21/54

(57) ABSTRACT

The disclosure relates to a vulnerability normalization service module that receives scan results of a source code that identifies a vulnerability in the source code and a scanning tool solution for the identified vulnerability. The vulnerability normalization service module extracts from the scan results a vulnerable code snippet that identifies the vulnerability. A remediation generation service module receives the vulnerable code snippet. The remediation generation service module generates itemized code snippets from the vulnerable code snippet by assigning unique vulnerability identifications to each identified vulnerability; generates optimized prompts by implementing prompt engineering techniques to analyze context of the itemized code snippets and each identified vulnerability and integrating solutions from a security solution catalog into the scanning tool solution based on the analyzed context; and sends the optimized prompts to a large language model (LLM) to generate pull-request-ready (PR-ready) remediation recommendations for each identified vulnerabilities.

### FIELD OF TECHNOLOGY

The present disclosure relates to the field of software security, specifically to systems and methods for analyzing and remediating vulnerabilities in software code using advanced prompt engineering techniques.

### BACKGROUND

Software vulnerabilities pose significant risks to the security and integrity of applications. Traditional methods of vulnerability analysis and remediation often lack the efficiency, relevance, and precision required to address these issues promptly. Some traditional static application security testing (SAST) tools that are used to identify vulnerabilities in application source code often fall short in offering practical and actional remediation recommendations. Consequently, developers who lack sufficient security training may struggle to understand the risk associated with these vulnerabilities and may not remediate them correctly or promptly.

### SUMMARY

Given the aforementioned deficiencies, there is a need for a system and method that analyzes and remediates vulnerabilities in software code using advanced prompt engineering techniques. This system should provide context-aware and organization-specific remediation to developers.

According to one aspect of the present disclosure, a computer-implemented method comprises receiving, at a vulnerability normalization service module, scan results of a source code that identifies a vulnerability in the source code and a scanning tool solution for the identified vulnerability; extracting, implemented by the vulnerability normalization service module, from the scan results a minimum amount of vulnerable code snippet from an area in the source code that contains the identified vulnerability; receiving, at a remediation generation service module from by the vulnerability normalization service module, the vulnerable code snippet; generating, by the remediation generation service module, itemized code snippets from the vulnerable code snippet by assigning unique vulnerability identifications to each identified vulnerability; generating, by the remediation generation service module, optimized prompts by: implementing prompt engineering techniques to analyze context of the itemized code snippets and each identified vulnerability; and integrating solutions from a security solution catalog into the scanning tool solution based on the analyzed context; and sending, by the remediation generation service module, the optimized prompts to a large language model (LLM) to generate pull-request-ready (PR-ready) remediation recommendations for each identified vulnerabilities.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1A illustrates an exemplary network system implementing an Intelligent Vulnerability Analysis and Remediation (iVar) system in accordance with embodiments of the present disclosure.

FIG. 1B illustrates an exemplary iVar system in accordance with the embodiments of the present disclosure.

FIG. 2 is a sequence diagram illustrating interaction between components of a network system that includes an iVar system in accordance with the embodiments.

FIG. 3 illustrates an example of an LLM Suite generated remediation recommendation in accordance with the embodiments of the present disclosure.

FIG. 4A illustrates an exemplary flow diagram of a pre-commit analysis process implemented by an iVar system in accordance with embodiments of the present disclosure.

FIG. 4B is an exemplary use case diagram depicting how an embodiment of an iVar system according to the present disclosure may be used by a developer to implement a pre-commit in accordance with embodiments of the present disclosure.

FIG. 4C is a sequence diagram illustrating interaction between components during a pre-commit analysis in accordance with the embodiments of the present disclosure.

FIG. 4D shows an example of a unified Diff format in accordance with the embodiments of the present disclosure.

FIG. 5A illustrates an exemplary flow diagram of a post-commit analysis process implemented by an iVar system in accordance with embodiments of the present disclosure.

FIG. 5B is an exemplary use case diagram depicting how an embodiment of an iVar system according to the present disclosure may be used by a developer to implement a post-commit analysis in accordance with the embodiments of the present disclosure.

FIG. 6 illustrates an iVar system deployed in a cloud computing environment in accordance with the embodiments of the present disclosure.

FIG. 7A illustrates an exemplary flow diagram of a vulnerability analysis and remediation process implemented by an iVar system in accordance with embodiments of the present disclosure.

FIG. 7B shows an example of a prompt generated by the iVar system in accordance with the embodiments of the present disclosure.

FIG. 8 illustrates an exemplary flow diagram of an iVar remediation auto-evaluation process implemented by an iVar system in accordance with embodiments of the present disclosure.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer-readable media having instructions stored thereon for one or more aspects of the present technology as described and illustrated by way of the examples herein. The instructions in some examples include executable code that, when executed by one or more processors, cause the processors to carry out blocks necessary to implement the methods of the examples of this technology that are described and illustrated herein.

Various embodiments in the present disclosure provide systems and methods for analyzing and remediating vulnerabilities in software code using advanced prompt engineering techniques.

In various embodiments, an iVar system may provide a comprehensive system configured to detect, analyze, and remediate vulnerabilities in software code. The iVar system may support both pre-commit and post-commit use cases, leveraging advanced prompt engineering techniques through an LLM suite (e.g., ChatGPT-4) to provide enhanced vulnerability analysis and pull-request-ready (PR-ready) remediation recommendations based on internal sanctioned systems tool kit (STK) solutions and industry-accepted solutions in cases where STK solutions are not available. The iVar system may integrate seamlessly with existing SAST tools, such as Snyk®, and may operate in both request-based and event-driven modes to ensure robust security throughout the software development lifecycle.

In embodiments, the iVar system may be configured to optimize the security of software analyzing and remediating vulnerabilities identified by SAST tools. The iVar system may leverage advanced prompt engineering techniques through the use of an LLM suite to deliver detailed, context-aware vulnerability and PR-ready remediation recommendations.

In embodiments, one aspect of the iVar system may include comprehensive indexing and cataloging of internally developed STK solutions. By providing the prompt specific vulnerability type, a prescriptive, concise description of the indexed STK solution, and the exact code snippet of the vulnerability, the iVar system may effectively narrow the LLM's degrees of freedom. This targeted approach may promote and ensure the generation of accurate and reliable remediations, significantly reducing the likelihood of LLM hallucinations and maintaining a sharp focus on the specific problem.

In embodiments, the iVar system's remediation recommendations may be based on an extensive catalog of internally developed STK solutions and, when necessary firm-sanctioned industry-accepted alternatives, to ensure that the remediation is highly relevant to the specific organizational and regulatory contexts and requirements of the identified vulnerabilities.

In another embodiment, by integrating seamlessly into development workflows, including but not limited to pre-commit and post-commit stages, the iVar system may provide real-time feedback and actionable insights, enabling developers to address security issues promptly and effectively. This proactive approach may ensure a secure codebase from the outset, significantly reducing the risk of vulnerabilities in production and enhancing overall security.

In embodiments, the iVar system may support a wide range of use cases from pre-commit to post-commit or any intermediate stage(s) therebetween, leveraging advanced prompt engineering techniques through the LLM suite to provide enhanced vulnerability analysis and PR-ready remediation recommendations. To effectively remediate issues, the PR-ready remediation recommendations may identify the problem, prioritize based on risk and impact, develop a plan, implement solutions, and ensure continuous monitoring and improvement.

To identify and assess the risks, the system may implement vulnerability scanning that may use tools to identify vulnerabilities in systems, applications, and networks. The system may perform risk assessments by evaluate the potential impact of each vulnerability, considering factors like likelihood of exploitation and potential damage. The system may also conduct a root cause analysis to determine the underlying causes of the issue to prevent recurrence.

The PR-ready remediation recommendations may prioritize and develop a plan to address the risk. Risk-based prioritization may be performed to focus on remediating vulnerabilities with the highest risk and impact. The remediation plan may include developing a plan outlining the steps for addressing each vulnerability, including timelines, resources, and responsibilities. The PR-ready remediation recommendations may produce document instructions that provide clear and concise instructions for remediation scenarios.

The PR-ready remediation recommendations may recommend solutions to implement including patch management, configuration changes, firewall/security software, and data remediation. The patch management may apply security patches and updates to address the vulnerabilities. The configuration changes may adjust system configurations to reduce risk. The firewall/security software may implement or enhance firewalls and security software to protect against threats. For data issues, data remediation may automate contextual awareness to ensure that the correct actions are identified.

The PR-ready remediation recommendations may recommend monitoring and improvements. The PR-ready remediation recommendations may recommend continuous monitoring by implementing tools and processes to continuously monitor for vulnerabilities and threats. Post-remediation review may be recommended to evaluate the effectiveness of remediation efforts and identify areas for improvement. Continuous improvements may be implemented by regularly reviewing and updating remediation processes to be proactive regarding evolving threats. Regular monitoring and testing may ensure that systems are functioning as intended and that issues are addressed promptly.

In embodiments, the iVar system may integrate seamlessly with existing SAST tools and operate in both request-based and event-driven modes. The iVar system may include a security solution catalog (SSC), which offers detailed usage descriptions for both internal STK (Security Tool Kit) solutions and industry-accepted third-party solutions.

In embodiments, the iVar system's innovative approach may include vulnerability normalization and solution placement, structured prompt recipe with well-defined ingredients, and the SSC. Ingredients of a prompt, just like a traditional recipe, are key components (“ingredients”) that must work together to help LLMs generate accurate and consistent responses.

The vulnerability normalization and solution placement may be handled by a vulnerability normalization service (VNS). The vulnerability normalization and solution placement may provide a process that shapes vulnerability scan results into a unified format and determines the best placement of the remediation (either at the source or the sink) depending on the vulnerability type.

The structured prompt recipe with well-defined ingredients may be managed by a prompt engine service (PES). The structured prompt recipe with well-defined ingredients may involve the detailed steps and guidelines for generating context-aware remediation prompts. The structured prompt recipe may include the following well-defined ingredients: background information, directive, main content, boundaries, sample inputs/outputs, and response structure. The background information may provide the context for the task. The directive may give the model a clear directive or action to perform.

The main content may include the specific data or content that the model needs to process or analyze. The boundaries may provide additional instructions that modify or refine the main instruction, setting boundaries or specific criteria for the model's response. The sample inputs/outputs may include sample inputs and outputs that demonstrate the desired behavior or format of the model's response. The response structure may specify the format in which the model's response should be structured.

The SSC may provide a comprehensive catalog indexed by programming language, infrastructure as code (laC), framework, vulnerability category, and subcategory, containing concise descriptions of solutions, including public interfaces, to enable security engineers to write code. The SSC may include both internally developed solutions and approved third-party or open-source libraries, all vetted to meet an organization's security standards.

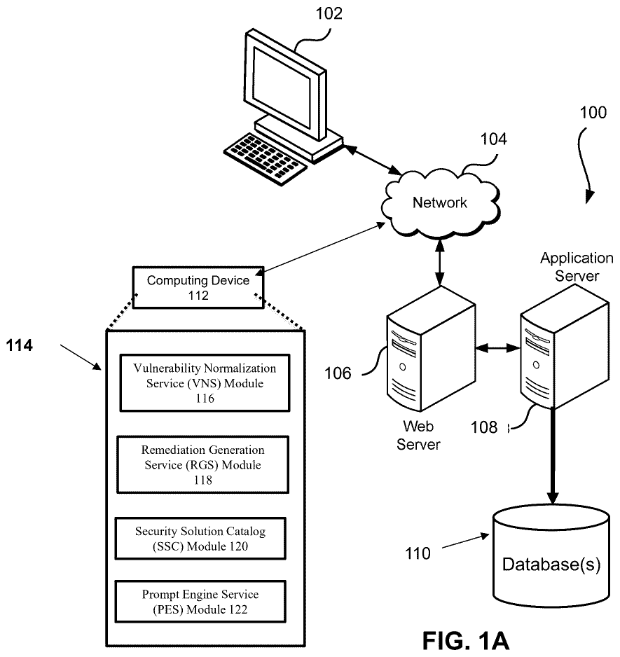

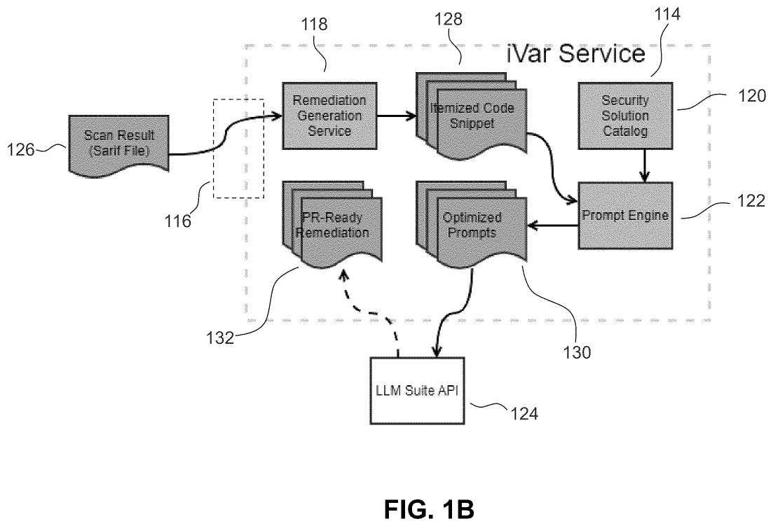

FIG. 1A illustrates an exemplary network system 100 implementing an iVar system in accordance with embodiments of the present disclosure. FIG. 1B illustrates an example of the iVar system 114 analyzing and remediating vulnerabilities in software code using advanced prompt engineering techniques described herein. The iVar system 114 may include a plurality of components or modules executed or otherwise implemented using at least one computing device 112.

For example, the iVar system 114, also shown in FIG. 1B, may include four main modules: a VNS module 116, a remediation generation service (RGS) module 118, an SSC module 120, and a PES module 122. The computing device 112 may be configured to execute or otherwise performs operations associated with the VNS module 116, the RGS module 118, the SSC module 120, and the PES module 122.

In some embodiments, one or more of the modules 116, 118, 120, and 122, may be implemented as code and/or machine-executable instructions executable by the computing device 112 that may represent one or more of a procedure, a function, a subprogram, a program, a routine, a subroutine, a module, a software package, a class, or any combination of instructions, data structures, or program statements, and the like. In other words, embodiments of the iVar system 114 described herein may be implemented by hardware, software, firmware, middleware, microcode, hardware description languages, or any combination thereof.

When implemented in software, firmware, middleware or microcode, the program code or code segments to perform the necessary tasks (e.g., a computer-program product) may be stored in a computer-readable or machine-readable medium, and a processor(s) associated with the computing device 112 that may perform the tasks defined by the code.

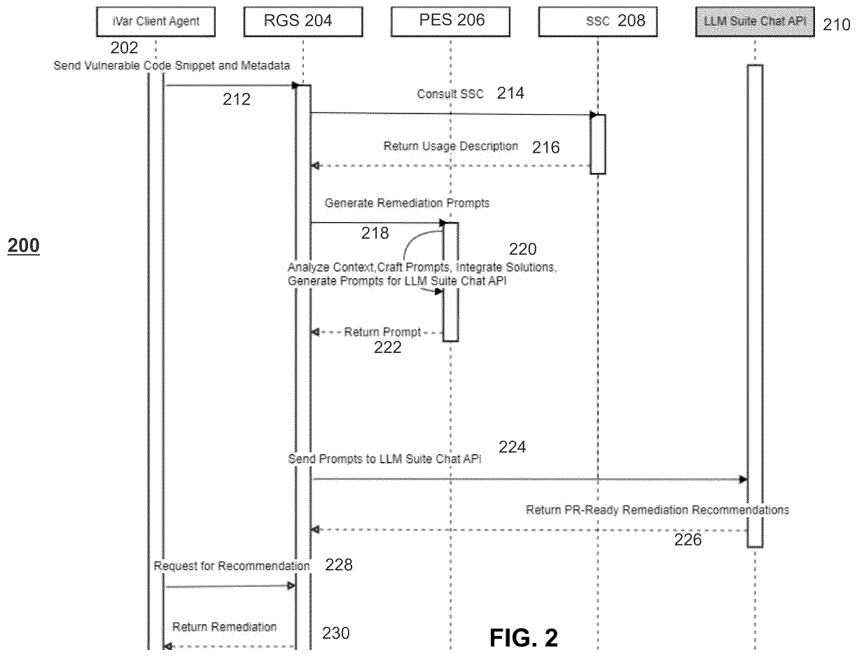

In various embodiments, the system and method of the present disclosure may solve the above-mentioned software code security problems utilizing the iVar system 114, which analyzes and remediates vulnerabilities in software code. As shown in the examples of FIGS. 1A-1B some of the main components of the iVar system 114 may include VNS module 116, the RGS module 118, the SSC module 120, and the PES module 122. The components of the iVar system 114 may perform various interactions with each other and additional systems and components. For simplicity and clarity, FIG. 1B illustrates a basic diagram of the interactions of the main components. FIG. 2 illustrates a sequence diagram that provides a more detailed description of the sequence of interactions between the components.

In various embodiments, the VNS module 116 may be configured to be responsible for the tasks of logging, tracking, and analyzing all issues and subsequent actions taken by engineers. The VNS module 116 may be configured to collect feedback from the log database and provide insights into vulnerabilities and actions taken. The VNS module 116 may be configured to reduce resolved vulnerabilities into possible feedback for improving scan rules and prompts, which may then be extracted periodically by security engineers to make final decisions on how to adopt them. Updates to the iVar system 114 may be manually reviewed and approved by engineers to ensure stability and avoid artificial intelligence (Al)-induced hallucinations. The resolved incident records may be purged by the VNS module 116 too.

The VNS module 116 may provide read-only endpoints for security engineers to extract feedback summaries and recommendations. The read-only endpoint may be an application programming interface (API) or database endpoint that allows only retrieval of data, wherein users can read (query) information but cannot modify, delete, or create new records. These endpoints may be used for fetching data while maintaining security and preventing unintended data changes.

The VNS module 116 may interact with the PES module 122 to generate prompts for log analysis and summarizing feedback. The VNS module 116 may also interact with various component to track and analyze all issues and subsequent actions taken by engineers to provide insights and improve the iVar system 114.

In embodiments, the VNS module 116 may be configured to handle vulnerability normalization and solution placement. The VNS module 116 may be configured to shape the vulnerability scan results 126 into a unified format that can be pragmatically incorporated into the prompt. The VNS module may be configured to determine the best placement of the remediation (either at the source or the sink) depending on the vulnerability type and extract a minimum amount of code snippet around the identified area.

The source is where data originates, and the sink is where the data is ultimately stored or processed. The source may be a database, file, API, or other data storage. The sink may be a database, file, cloud storage, or another data storage. In the example, “Extracting customer data from the customer database, cleaning it, and loading it into the data warehouse”, the source is the customer database, and the sink is the data warehouse.

In various embodiments, the RGS module 118 may be configured to function as the central entry point for both pre-commit and post-commit processes to interact with the iVar system 114. The RGS module 118 may be configured to generate PR-ready remediation suggestions based on discovered vulnerabilities. The RGS module 118 may be configured to log the generated remediation recommendations for tracking and feedback purposes. The RGS module 118 may be configured to store the PR-ready remediation recommendations in the core services' internal databases.

The RGS module 118 may receive vulnerable code snippets and metadata from pre-commit and post-commit processes. The metadata may include, for example, vulnerability names, seal-id, project name, file name, etc. The RGS module 118 may use the PES module 122 to enhance remediation recommendations and reference the SSC module 120 for internal STK solutions and firm-approved industry-accepted third-party solutions. The RGS module 118 may send the prompts to the LLM Suite Chat API 124 to generate PR-ready code snippets.

In embodiments, the RGS may be configured to orchestrate and execute the various components to generate PR-ready remediation suggestions. The RGS module 118 may be configured to receive vulnerable code snippets and metadata. The RGS module 118 may use the PES module 122 to enhance remediation generation. The RGS module 118 may be configured to reference the SSC module 120 for internal STK solutions and industry-accepted third-party solutions. The RGS module 118 may send prompts to an LLM Suite Chat API 124 to generate PR-ready code snippets. The LLM Suite Chat API 124 may be configured as an LLM chatbot which is an advanced bot that understands context, handles complex questions, and even engages in casual, human-like (e.g., human-simulated) conversation.

In various embodiments, the SSC module 120 may be configured to provide a comprehensive catalog of solutions. The SSC module 120 may be configured to serve as a lookup table that, given a vulnerability category (e.g., XSS), returns the usage description for either an internal STK solution or an organization-approved external library. This usage description of how to use the STK/Library may be included as part of the prompt sent to the LLM Suite Chat API 124.

In various embodiments, the SSC module 120 may be configured to perform various functions including indexing, solution descriptions, and subtype handling. The SSC module 120 may be configured to index by, for example, programming language, infrastructure as code (laC), framework, vulnerability category, and subcategory. The SSC module 120 may contain concise descriptions of solutions, including public interfaces, to enable security engineers to write code. Namely, the SSC module 120 may be configured to provide solutions that are concise, prescriptive, and organization relevant solutions that are integrated into optimized prompts. These solutions may include both internally developed solutions and approved third-party or open-source libraries, all vetted to meet an organization's security standards. The SSC module 120 may be configured to provide specific solutions for subtypes of vulnerabilities, including examples. When a vulnerability type includes subtypes, all relevant subtype solutions may be included in the prompt, and the chatbot may be instructed to identify the specific subtype and apply the corresponding solution.

In embodiments, the SSC module 120 may be configured to provide create read update delete (CRUD) endpoints for security engineers to update the catalog. The SSC module 120 may be consulted by the PES module 122 to provide usage descriptions for internal STK solutions or external libraries, which may then be included in the prompts sent to the LLM Suite Chat API 124.

In various embodiments, the PES module 122 may be configured to manage the prompt recipe for generating detailed and context-aware remediation prompts. The PES module 122 may be configured to be responsible for generating detailed and context-aware remediation prompts for identified vulnerabilities in code snippets. The PES module 122 may be configured to enhance the remediation process by analyzing the context of the code and the specific vulnerability, crafting precise remediation prompts, and integrating solutions from the SSC module 120. The prompts generated by the PES module 122 may then be used by the RGS module 118 to interact with the LLM Suite Chat API 124.

The PES module 122 may be configured to perform several interactions, such as analyzing context, crafting remediation prompts, integrating solutions, and providing prompts to RGS module 118. The PES module 122 may analyze context to gain an understanding of the context of the code snippet and the specific vulnerability. In crafting remediation prompts, the PES module 122 may generate detailed prompts that describe the vulnerability and suggest possible fixes. The PES module 122 may employ integrating solutions to incorporate solutions from the SSC module 120 into the remediation suggestions. The PES module 122 may provide the RGS module 118 with prompts to be sent to the LLM Suite Chat API 124.

As further shown in FIG. 1A, the network system 100 may further include the iVar system 114 through the use of computing device 112 may be coupled to a plurality of server devices 106, 108 that hosts a plurality of database(s) 110, and also to a plurality of client devices 102 via communication network(s) 104. A communication interface of the iVar system 114, such as a network interface of a computer system, operatively couples and communicates between the iVar system 114, the server devices 106, 108, and/or the client device(s) 102, which are all coupled together by the communication network(s) 104, although other types and/or numbers of communication networks or systems with other types and/or numbers of connections and/or configurations to other devices and/or elements may also be used.

The communication network(s) 104 may be exemplary as described with respect to FIG. 1A, although the iVar system 114, the server devices 106, 108, and/or the client device(s) 102 may be coupled together via other topologies. Additionally, in a network environment, the iVar system 114 may include other network devices such as one or more routers and/or switches, for example, which are well known in the art and thus will not be described herein.

By way of example only, the communication network(s) 104 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used and are within the spirit and scope of the embodiments. The communication network(s) 104 in this example may employ any suitable interface mechanisms and network communication technologies including, for example, tele-traffic in any suitable form (e.g., voice, modem, and the like), public switched telephone network (PSTNs), Ethernet-based packet data networks (PDNs), combinations thereof, and the like.

The iVar system 114 may be a standalone device or integrated with one or more other devices or apparatuses, such as one or more of the server devices 106, 108, for example. In one particular example, the iVar system 114 may be hosted by one of the server devices 106, 108, and other arrangements are also possible. Moreover, one or more of the devices of the iVar system 114 may be hosted in the same or a different communication network including one or more public, private, or cloud networks, for example.

Any of the server devices 106 and 108 may include, among other features, one or more processors, a memory, and a communication interface, which are coupled together by a bus or other communication link, although other numbers and/or types of network devices may be used. The server devices 106, 108 in this example may process requests received from the iVar system 114 via the communication network(s) 104 according to the hypertext transfer protocol (HTTP) and/or JavaScript object notation (JSON) protocol. Other known protocols are envisioned and are within the spirit and scope of the embodiments.

The server devices 106, 108 may be hardware or software or may represent a system with multiple servers in a pool, which may include internal or external networks. The server devices 106, 108 may host the database(s) 110 that are configured to store metadata sets, data quality rules, and newly generated data.

Although the server devices 106, 108 are illustrated as single devices, one or more actions of each of the server devices 106, 108 may be distributed across one or more distinct network computing devices that together comprise one or more of the server devices 106, 108. Moreover, the server devices 106, 108 are not limited to a particular configuration. The server devices 106, 108 may contain a plurality of network computing devices that operate using a master/slave approach, whereby one of the network computing devices of the server devices 106, 108 operates to manage and/or otherwise coordinate operations of the other network computing devices.

The server devices 106, 108 may operate as a plurality of network computing devices within a cluster architecture, a peer-to-peer architecture, virtual machines (VMs), or within a cloud architecture, for example. Thus, the technology disclosed herein is not to be construed as being limited to a single environment, and other configurations and architectures are also envisaged.

Client device 102, in this context, refers to any computing device that interfaces to the communications network(s) 104 to obtain resources from one or more server devices 106, 108 or other client device(s) 102.

In some embodiments, the client device(s) 102 in this example may include a specific type of computing device that can facilitate the implementation of the iVar system 114 that may automatically migrate a set of rules from one platform to another platform, but the disclosure is not limited thereto.

Accordingly, the client device(s) 102 may be mobile computing devices, desktop computing devices, laptop computing devices, tablet computing devices, VMs (including cloud-based computers), for example.

The client device(s) 102 may run interface applications, such as standard web browsers or standalone client applications, which may provide an interface to communicate with the iVar system 114 via the communication network(s) 104 to communicate user requests. The client device(s) 102 may further include, among other features, a display device, such as a display screen or touchscreen, and/or an input device, such as a keyboard, for example.

Although the network system 100 with the iVar system 114, the server devices 106, 108, the client device(s) 102, and the communication network(s) 104 are described and illustrated herein in a network environment, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network system 100, such as the iVar system 114, the server devices 106, 108, or the client device(s) 102, for example, may be configured to operate as virtual instances on the same physical machine. For example, one or more of the iVar system 114, the server devices 106, 108, or the client device(s) 102 may operate on the same physical device rather than as separate devices communicating through the communication network(s) 104. Additionally, there may be more or fewer iVar system 114, server devices 106, 108, or client device(s) 102 than illustrated in FIG. 1A.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, PDNs, the Internet, intranets, and combinations thereof.

FIG. 1B is a block diagram of functional elements of the iVar system 114 for analyzing and remediating vulnerabilities in software code using advanced prompt engineering techniques. The iVar system may employ prompt engineering techniques to craft the input to a generative AI model to elicit the most effective and relevant output. Through the use of prompt engineering, the iVar system 114 may provide a process of designing inputs for AI tools that may produce optimal outputs. Better inputs into the generative AI may produce better results. Herein, these inputs are referred to as “prompts.” By employing prompt engineering techniques, the iVar system 114 may provide a deterministic solution which mitigates the hallucinations in AI outputs.

In some embodiments, the prompt engineering techniques may include, for example, zero-shot prompting, few-shot prompting, chain-of-thought (CoT) prompting, and prompt chaining. Zero-shot prompting may provide the AI direct instructions or asking a question to a model without additional information. Few-shot prompting may supply the AI with a few examples to guide its output. CoT prompting may break down complex reasoning into intermediate steps. Prompting chaining may involve splitting a complex task into smaller subtasks.

Referring to FIG. 1B, the iVar system 114 may receive scan results 126 of source code as input. A scanning tool, for example, a SAST tool, such as Snyk®, may be used to identify vulnerabilities in the code and generate scan results. When the scanning tool completes the scanning, a SAST completion event may be generated, signalling the end of the scanning. The iVar core services in the iVar system 114 may be triggered by the SAST completion event to request the scan results. The iVar core services may use the retrieved scan results to generate the PR-ready remediation 132.

The VNS module 116 may be configured to normalize the scan results into a unified format that can be pragmatically incorporated into the prompt. The VNS module 116 may be used to determine the best placement of the remediation (either at the source or the sink) depending on the vulnerability type and extract a minimum amount of code snippet around the identified area.

In various embodiments, the RGS module 118 may be configured to function as the central entry point for both pre-commit and post-commit processes to interact with the iVar system 114. The RGS module 118 may receive the normalized vulnerability scan results and metadata. The RGS module 118 may receive vulnerable code snippets and metadata from pre-commit and post-commit processes. The metadata may include, for example, vulnerability names, seal-id, project name, file name, etc. The RGS module 118 may use the PES module 122 to enhance remediation recommendations and reference the SSC module 120 for internal STK solutions and firm-approved industry-accepted third-party solutions. The RGS module 118 may send the prompts to the LLM Suite Chat API 124 to generate PR-ready code snippets. The RGS module 118 may be configured to generate PR-ready remediation suggestions 132 based on discovered vulnerabilities.

Upon receiving the vulnerable code and metadata, the RGS module 118 may assign unique vulnerability identifications. The RGS module 118 may generate itemized code snippets 128 by assigning the unique vulnerability identifications. Each identified vulnerability may be assigned a unique identification (ID) hash. This hash may be generated using consistent attributes such as the repository path, vulnerability type, line number of the vulnerability source, etc., to ensure uniqueness and traceability. This may allow clients to query the remediation for that vulnerability using the same hash.

The RGS module 118 may consult the SSC module 120 to find appropriate internal STK solutions or an organization-approved external libraries for the identified vulnerabilities. The SSC module 120 may be configured to provide a comprehensive catalog of solutions. The SSC module 120 may be configured to serve as a lookup table that, given a vulnerability category (e.g., XSS), returns the usage description for either an internal STK solution or an organization-approved external library. This usage description of how to use the STK/Library may be included as part of the prompt sent to the LLM Suite Chat API 124.

In various embodiments, the PES module 122 may be configured to manage the prompt recipe for generating detailed and context-aware remediation prompts. The PES module 122 may be configured to be responsible for generating detailed and context-aware remediation prompts for identified vulnerabilities in code snippets. The PES module 122 may be configured to enhance the remediation process by analyzing the context of the code and the specific vulnerability, crafting precise remediation prompts, and integrating solutions from the SSC module 120. The prompts generated by the PES module 122 may then be used by the RGS module 118 to interact with the LLM Suite Chat API 124.

The PES module 122 may be configured to perform several interactions, such as analyzing context, crafting remediation prompts, integrating solutions, and providing prompts to RGS module 118. The PES module 122 may analyze context to gain an understanding of the context of the code snippet and the specific vulnerability. In crafting remediation prompts, the PES module 122 may generate detailed prompts that describe the vulnerability and suggest possible fixes. The PES module 122 may employ integrating solutions to incorporate solutions from the SSC module 120 into the remediation suggestions. The PES module 122 may provide the RGS module 118 with prompts to be sent to the LLM Suite Chat API 124.

The RGS module 118 may interact with the PES module 122 to generate remediation prompts. The PES module 122 may play a crucial role in this process by: analyzing the context, crafting remediation prompts, integrating solutions, and producing optimized prompts 130 for the LLM Suite Chat API 124. The PES module 122 may analyze the context to gain an understanding of the context of the code snippet and the specific vulnerability. The PES module 122 may generate detailed prompts that describe the vulnerability and suggest possible fixes. The PES module 122 may incorporate solutions from the SSC module 120 into the remediation suggestions. The PES module 122 may produce optimized prompts 130 to be sent to the LLM Suite Chat API 124. The SSC module 120 may be configured to provide solutions that are concise, prescriptive, and organization relevant solutions that are integrated into the optimized prompts 130.

The optimized prompts may be sent to the LLM Suite Chat API 124 to generate PR-ready remediation recommendations 132. The LLM Suite Chat API 124 may return the PR-ready remediation recommendations 132 to the RGS module 118. The RGS module 118 may log the generated remediation recommendations via the VNS module 116 for tracking and feedback purposes. The RGS module 118 may store the PR-ready remediation recommendations 132 in the core services' internal database so that they may be displayed to the developers.

FIG. 2 is a sequence diagram 200 illustrating how an iVar client agent 202, RGS module 204, PES module (prompt engine) 206, SSC module 208, and LLM Suite Chat API 210 of iVar system 114 may interact with each other according to various embodiments. As shown in FIG. 2, at 212, the iVar client agent 202 may send vulnerable code and metadata to the RGS module 204. The RGS module 204 may receive the vulnerability scan results, which include the vulnerable code snippet and its metadata, from either the pre-commit or post-commit process. The metadata may include, for example, vulnerability names, seal-id, project name, file name, etc.

Upon receiving the vulnerable code and metadata at 212 from the iVar client agent, in some embodiments, the RGS module 204 may assign unique vulnerability identifications. The RGS module 204 may generate itemized code snippets 128 by assigning the unique vulnerability identifications. Each identified vulnerability may be assigned a unique hash, as noted above.

At 214, the RGS module 204 may consult the SSC module 208 to find appropriate internal STK solutions or an organization-approved external libraries for the identified vulnerabilities. At 216, the SSC module 208 may return the usage description to the RGS module 204.

At 218, the RGS module 204 may interact with the PES module 206 to generate remediation prompts. The RGS module 204 may use the PES module 206 to enhance the remediation suggestions.

At 220, the PES module 206 may play a crucial role in this process by: analyzing the context, crafting remediation prompts, integrating solutions, and producing optimized prompts 130 for the LLM Suite Chat API 210. The PES module 206 may analyze the context to gain an understanding of the context of the code snippet and the specific vulnerability. The PES module 206 may generate detailed prompts that describe the vulnerability and suggest possible fixes. The PES module 206 may incorporate solutions from the SSC into the remediation suggestions. The PES module 206 may produce optimized prompts 130 to be sent to the LLM Suite Chat API 210.

At 222, the PES module 206 may return the optimized prompts 130 to the RGS module 204. The RGS may interact with the LLM Suite Chat API 210. At 224, the RGS module 204 may send the optimized prompts to the LLM Suite Chat API 210 to generate PR-ready remediation recommendations 132 (PR-ready code snippets).

At 226, the LLM Suite Chat API 210 may return the PR-ready remediation recommendations 132 to the RGS module 204. The RGS module 204 may log the generated remediation recommendations via the VNS module 116 for tracking and feedback purposes. The RGS module 204 may store the PR-ready remediation recommendations 132 in the core services' internal database so that they may be displayed to the developers.

At 228, the developer through the use of the iVar client agent 202 may send a request to the RGS module 204 for the PR-ready remediation recommendation 132.

At 230, in response to the request, the RGS module 204 may return PR-ready remediation recommendation 132 to the developer via the iVar client agent 202. The developer may review the PR-ready remediation recommendation 132 and apply the recommended fixes. User feedback may be collected via subsequent commits of the same files. The VNS module 116 may track the actions taken by the developer and collect feedback for further analysis and improvement.

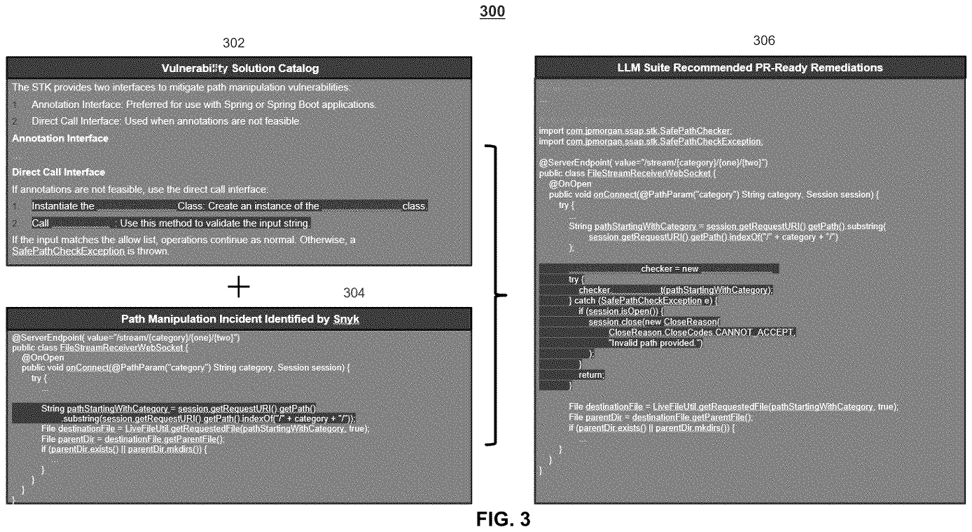

FIG. 3 illustrates an example 300 of an LLM Suite generated remediation recommendation of a path manipulation vulnerability. In FIG. 3, a SAST tool 304, such as Snyk®, may identify a path manipulation vulnerability in a software code. A vulnerability solution catalog 302 may provide a solution for the path manipulation vulnerability. The LLM Suite generated remediation recommendation 306 may seamlessly integrate the solution provided by the vulnerability solution catalog 302 with the SAST tool 304 identified vulnerability.

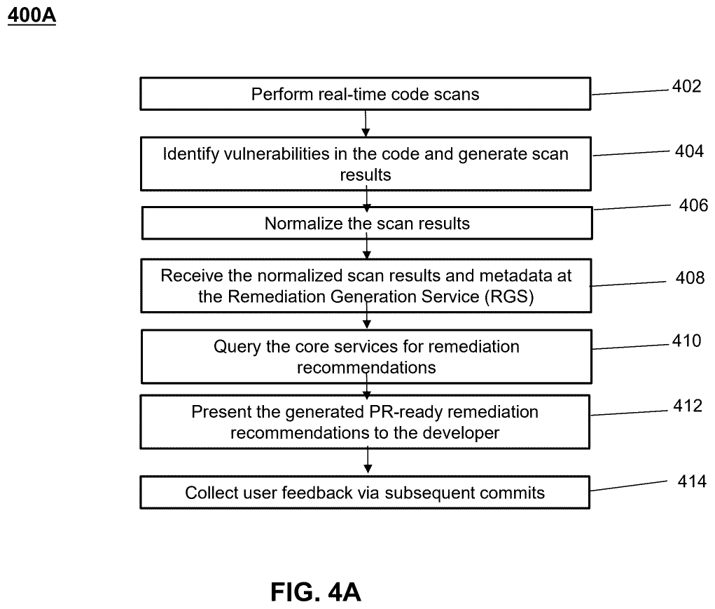

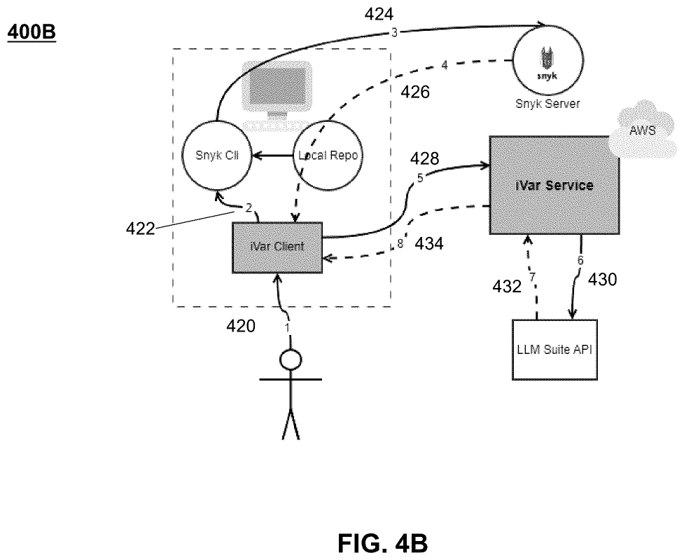

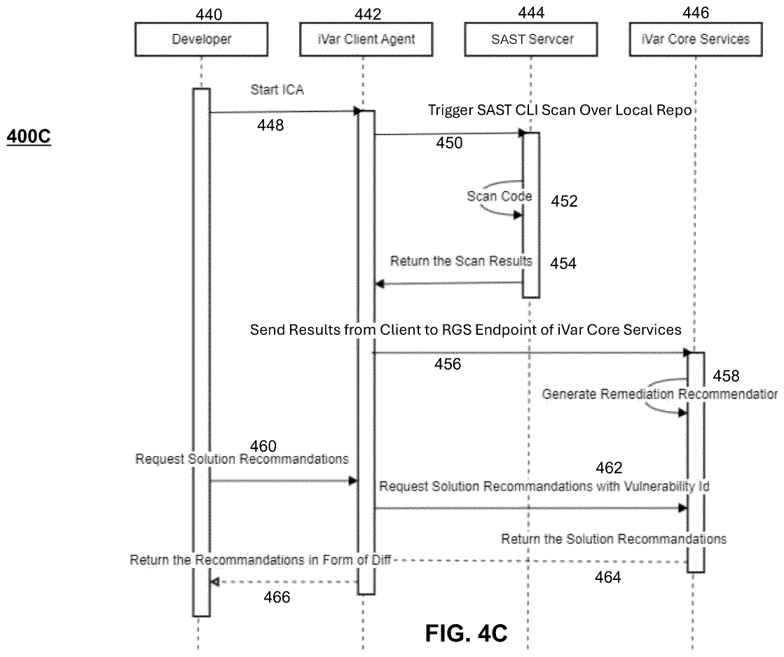

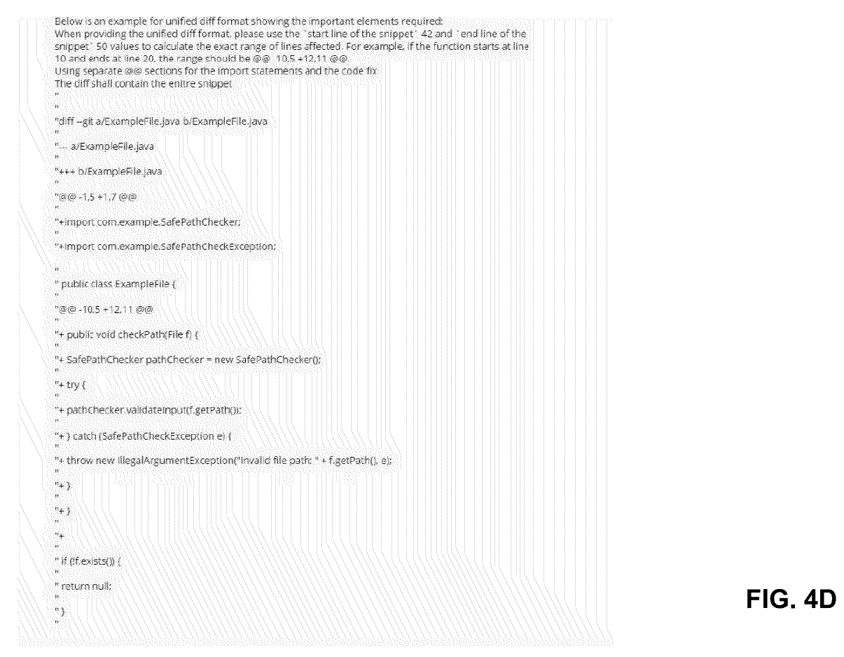

FIG. 4A illustrates an example flow diagram of a pre-commit analysis process 400A implemented by the iVar system in accordance with embodiments of the present disclosure.

The pre-commit analysis may be configured to focus on identifying and remediating vulnerabilities before the code is committed to a repository. This ensures that vulnerabilities are addressed early in the development process, reducing the risk of introducing security issues into the codebase. The pre-commit analysis may be configured to analyze code snippets to identify specific types of vulnerabilities, such as Open Web Application Security Project (OWASP) Top 10 which is a list of the most critical web application security risks.

During the pre-commit analysis, the iVar system may be configured to proactively focus on pre-commit analysis to prevent vulnerabilities from entering the codebase. The pre-commit analysis may integrate with the developer's local environment to perform real-time code scans using a SAST CLI (Command Line Interface). The SAST Command Line Interface (CLI) (e.g., Snyk® CLI) may function as a tool that allows a developer to scan and monitor software code for security vulnerabilities, enabling the developer to find and fix them, either manually or as part of a Continuous Integration and Continuous Delivery/Deployment (CI/CD) workflow.

In various embodiments, the scan results and iVar remediation recommendations may be presented directly in the developer's console and integrated development environment (IDE). This workflow configuration may ensure that security checks are seamlessly integrated into the development workflow, providing immediate feedback and preventing vulnerabilities before code is committed.

In FIG. 4A, at 402, the process may perform real-time code scans. The developer's local environment may be integrated with a vulnerability scanning tool for example, SAST CLI, such as Snyk® CLI to perform real-time code scans. An iVar Client Agent may trigger the SAST CLI to scan the codebase for vulnerabilities.

At 404, the process may identify vulnerabilities in the code and generate scan results using the scanning tool. The iVar Client Agent may analyze the code snippets and identify the vulnerabilities.

At 406, the process may normalize the scan results. The VNS may normalize the scan results into a unified format.

At 408, the process may receive the normalized scan results and metadata at the RGS module. The RGS module may also consult the SSC module and use the PES module to generate detailed remediation prompts. The iVar Client Agent may send the results, including the offending code snippets and metadata to the RGS module. The RGS module may generate the PR-ready remediation suggestions, enhanced by the PES module and referencing the SSC module for internal STK solutions or industry-standard libraries.

At 410, the process may query the core services for remediation recommendations. The iVar Client Agent may use the unique vulnerability identifications to query the core services for remediation recommendations.

At 412, the process may present the generated PR-ready remediation recommendations to the developer. The generated PR-ready remediation recommendations may be presented directly in the developer's console or integrated development environment (IDE). The developer may review and apply the recommended fixes before committing the code. The core services may return PR-ready diffs as part of the remediation recommendations to the iVar Client Agent. The iVar Client Agent may display the remediation recommendations to the developer in the form of PR-ready diffs. The “PR-ready diff” refers to a pull request (PR) that is in a state where the changes are ready for review and potential merging, and the diff (the set of changes) is complete and accurate.

At 414, the process may collect user feedback via subsequent commits of the same files to improve the system. The developer may review and apply the recommended fixes. Feedback may be collected via subsequent commits of the same files.

FIG. 4B is an exemplary use case diagram depicting how an embodiment of the iVar system 400B according to the present disclosure may be used by a developer to implement a pre-commit.

At 420, the iVar system 400B may allow a developer to invoke an iVar Client.

At 422, the iVar Client may invoke a SAST CLI, such as Snyk® CLI.

At 424, the SAST CLI may send local code to the SAST server for scanning.

At 426, the SAST server may return the scan results to the iVar Client.

At 428, the iVar Client may send the scan results to the iVar server.

At 430, the iVar server may analyze the vulnerabilities and send prompts to the LLM Suite API.

At 432, the iVar server may generate remediation recommendations.

At 434, the iVar server may return the remediation recommendations the iVar Client.

FIG. 4C is a sequence diagram illustrating how a developer 440, an iVar client agent 442, a SAST service 444, and an iVar client agent 446 may interact with each other during a pre-commit analysis 400C according to various embodiments. As shown in the sequence diagram of FIG. 4C, at 448, the developer 440 may start the iVar Client Agent 442.

At 450, the iVar Client Agent 442 may trigger the SAST CLI (e.g., Snyk® CLI) to scan the codebase for vulnerabilities at the SAST server 444.

At 452, the SAST server 444 may perform the scanning of the code.

At 454, the SAST server 444 may return the scan results to the iVar Client Agent 442.

At 456, the iVar Client Agent 442 may send the scan results the RGS endpoint to the iVar Core Services 446.

At 458, the iVar Core Services 446 may generate the remediation recommendation.

At 460, the developer 440 may request the solution recommendations from the iVar Client Agent 442.

At 462, the iVar Client Agent 442 may request the solution recommendations with vulnerabilities identification from the iVar Core Services 446.

At 464, the iVar Core Services 446 may return the solution recommendations to the iVar Client Agent 442.

At 466, the iVar Client Agent 442 may return the recommendations in the form of a Diff to the developer 440. FIG. 4D shows an example of a unified Diff format.

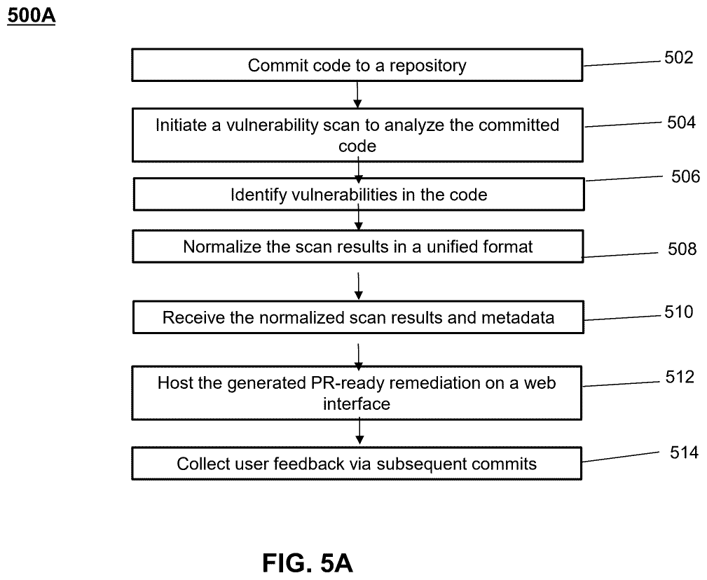

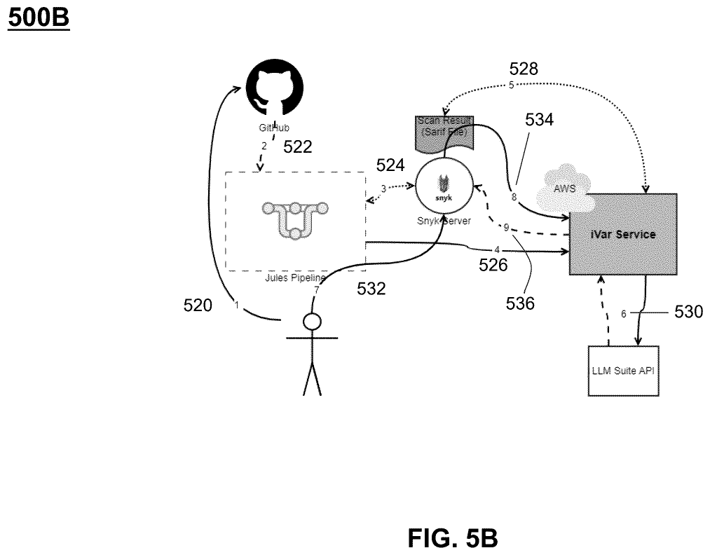

FIG. 5A illustrates an example 500A flow diagram of a post-commit analysis process implemented by the iVar system in accordance with embodiments of the present disclosure.

The post-commit analysis may be configured to focus on identifying and remediating vulnerabilities after the code has been committed to the repository. This ensures that any vulnerabilities introduced during the commit process are promptly addressed.

During the post-commit analysis, the iVar system may be configured to reactively perform post-commit analysis triggered by events such as SAST scan completions. The post-commit analysis may scan results, generate remediation recommendations, and host these recommendations on a web interface for engineers to review. Additionally, the post-commit analysis may integrate with the SAST to embed links to the hosted remediation results within the a SAST's scan results, providing a unified view of vulnerabilities and their fixes. The post-commit analysis may ensure that vulnerabilities identified after code commits are effectively remediated and tracked, enhancing the overall security posture of the codebase.

In FIG. 5A, at 502, the process may commit code to a repository. A developer may commit code to a version control system (e.g., GitHub), triggering a CI/CD pipeline (e.g., Jenkins pipeline, which also may be referred to as a Jules Pipeline). The developer may make changes to the codebase and commit the code to the repository of the version control system. The commit action may trigger the pipeline to start the CI/CD.

At 504, the process may initiate a vulnerability scan to analyze the committed code. The CI/CD pipeline may initiate the vulnerability scan using a SAST tool (e.g., Snyk®) to analyze the committed code. The pipeline may initiate the SAST tool scan to analyze the codebase for vulnerabilities.

At 506, the process may identify vulnerabilities in the code. The scanning tool may identify vulnerabilities in the code and generate scan results. When the scanning tool completes the scanning, a SAST completion event may be generated, signalling the end of the scanning. The iVar core services may be triggered by the SAST completion event to request the scan results. The iVar core services may use the retrieved scan results to generate the PR-ready remediation.

At 508, the process may normalize the scan results in a unified format using the VNS module.

At 510, the process may receive the normalized scan results and metadata. The RGS module may receive the normalized scan results and metadata, consult the SSC module, and use the PES to generate detailed remediation prompts.

At 512, the process may host the generated PR-ready remediation on a web interface. The generated PR-ready remediation recommendations may be hosted on the web interface for engineers to review. Additionally, links to the hosted remediation results may be embedded within the scanning tool's scan results, providing a unified view of vulnerabilities and their fixes. The developer may request remediation recommendations for specific vulnerabilities identified in the scan results. The SAST (or the developer via the SAST) may send a request to the iVar core services for the remediation recommendations. The iVar core services may return the PR-ready remediation recommendations to the SAST (or directly to the developer), which may be displayed in the developer's environment.

At 514, the process may collect user feedback via subsequent commits.

FIG. 5B is an exemplary use case diagram depicting how an embodiment of the iVar system 500B according to the present disclosure may be used by a developer to implement a post-commit.

At 520, the iVar system 500B may allow the developer to commit code to a version control system (e.g., GitHub).

At 522, the commit may trigger the CI/CD pipeline (e.g., Jules pipeline).

At 524, the CI/CD pipeline may start the SAST scan.

At 526, the CI/CD pipeline may emit a SAST complete event trigger to the iVar services.

At 528, the iVar services may request and receive the SAST scan results.

At 530, the iVar service may generate remediation recommendations.

At 532, the developer may request the remediation recommendations.

At 534, the SAST tool may request the remediation recommendations on behalf of the developer.

At 536, the iVar server may return the remediation recommendations from the iVar services to the SAST tool.

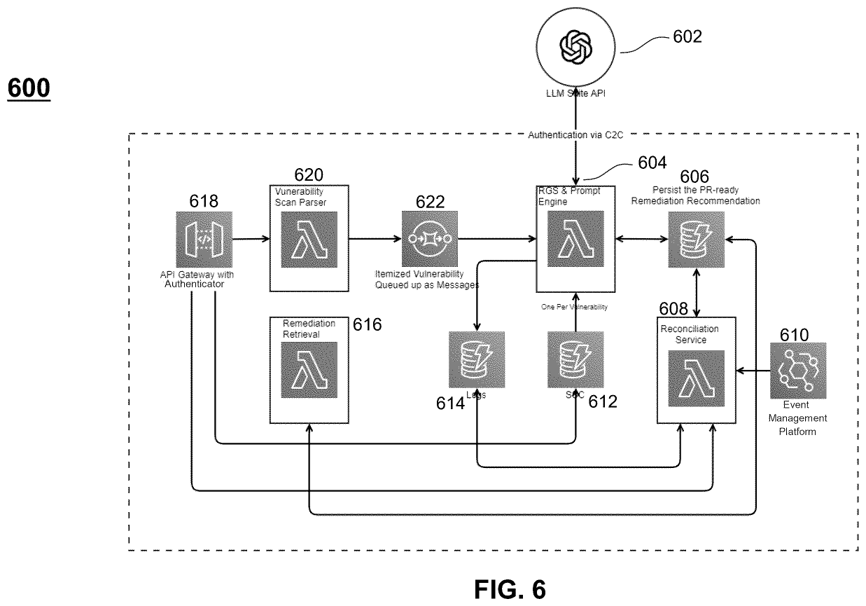

FIG. 6 illustrates an iVar system deployed in a cloud computing environment 600 according to an embodiment. The cloud computing environment 600 may be a distributed computing environment configured to provide services. A cloud computing environment may provide services through a service-oriented architecture.

As an example, the cloud computing environment may be a client or server, accessing or hosting any applications and/or data through any delivery paradigm. Such paradigms include, but are not limited to, remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS). These paradigms also include framework as a service (FaaS), backend as a service (BaaS), mobile backend as a service (MBaaS), infrastructure as a service (IaaS), etc.); and/or a hybrid model including any combination of the foregoing examples or other services or delivery paradigms. In an embodiment, the system may run on a distributed computing infrastructure, such as a cloud architecture, such as the Amazon Web Services™ (AWS™) architecture, among others.

The cloud computing environment 600 may include multiple cloud computing resources, such as servers, data storage repositories, computing services, communication platforms, virtual development environments, software, and/or other components and/or other services. The cloud computing resources may be distributed across multiple geographic regions. Each of the cloud computing resources may be related to other cloud computing resources. For example, a server of the cloud computing environment may utilize specified data storage repositories in the cloud computing environment.

In the example shown in FIG. 6, the cloud computing environment 600 may include computing services 604, 608, 616, 620, data storage devices 606, 612, 614, API Gateway 618, an event management platform 610, and a queue service 622. In the cloud computing environment 600, the services may operate in parallel to quickly analyze and remediate vulnerabilities in software code using advanced prompt engineering techniques, as described herein. In an embodiment, some of the services of the cloud computing environment 600 may be event-driven wherein a function may be invoked immediately when a specified event occurs.

The first computing service 604, the second computing service 608, the third computing service 616, and the fourth computing service 620 may each be a computing platform activated by an event-driven workstream. In response to receiving events, the first, second, third, and/or fourth computing services 604, 608, 616, 620 may execute code. Whenever a scan result is transferred from the LLM Suite API 602 into the cloud computing environment 600 through authentication via cloud-to-cloud (C2C) at the first computing service 604, the event may trigger the functions of the RGS and Prompt Engine. The second computing service 608 may perform reconciliation service. The third computing service 616 may perform remediation retrieval. The fourth computing service 620 may be configured to perform as a vulnerability scan parser.

The data storage devices 606, 612, 614 may be used to store and retrieve data and capture data modifications (inserts, updates, deletes) in a stream, which may be used to trigger the function of one or more of the computing services. The data storage device 606 may persist the PR-ready remediation recommendation so that the data remains after the application is closed. The data storage device 612 may be configured as the SSC. The SSC may provide a comprehensive catalog indexed by programming language, infrastructure as code (laC), framework, vulnerability category, and subcategory, containing concise descriptions of solutions, including public interfaces, to enable security engineers to write code. The data storage device 614 may be configured as a log database to log the data.

The API Gateway with authenticator 618 may be configured to restrict access and to authenticate the user. The queue service 622 may queue the itemized vulnerability as messages. The event management platform may be a serverless service that enables asynchronous communication between other computing services and third-party SaaS applications. The communication may be based on events, and the queue service 622 may be configured to add a layer of intelligence.

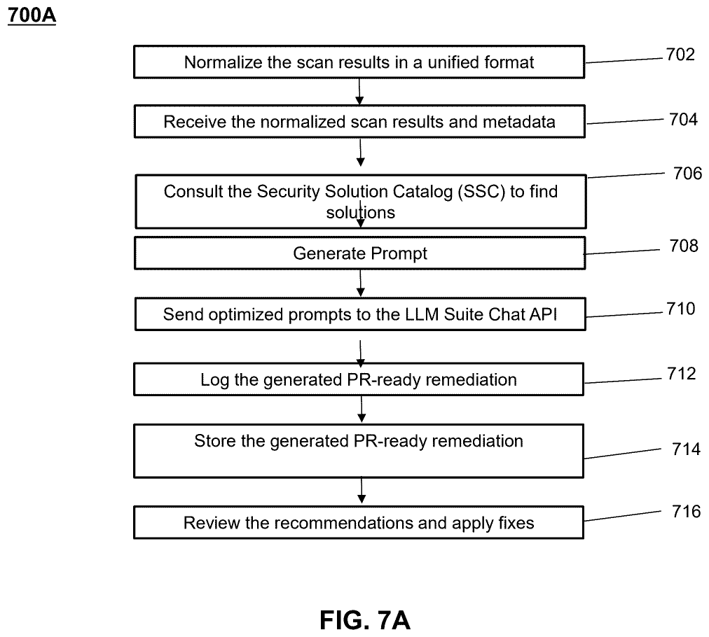

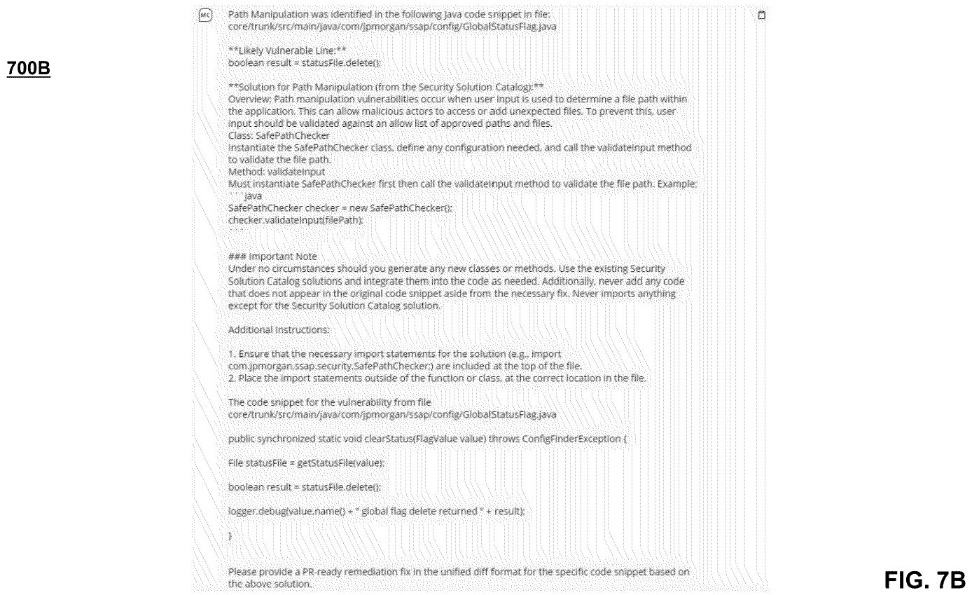

FIG. 7A illustrates an exemplary flow diagram of a vulnerability analysis and remediation process 700A implemented by an iVar system in accordance with embodiments of the present disclosure. FIG. 7B shows an example of a prompt 700B generated by the iVar system in accordance with the embodiments of the present disclosure.

At 702, the process may normalize the scan results in a unified format. The VNS may normalize the scan results into a unified format that can be pragmatically incorporated into the prompt 700B. The VNS may determine the best placement of the remediation (either at the source or the sink) depending on the vulnerability type and extracts just enough code snippet around the identified area.

At 704, the process may receive the normalized scan results and metadata. The RGS may receive normalized vulnerability scan results and metadata.

At 706, the process may consult the SSC module to find appropriate internal STK solutions or an organization-approved external libraries for the identified vulnerabilities.

At 708, the process may generate a prompt as shown in FIG. 7B. The prompt generation may involve background information, directive, main content, boundaries, sample inputs/outputs and response structure as follows:
a) As background information, The RGS may use the Prompt Engine Service (PES) to provide the context for the task. This may set the stage for what the model needs to understand before generating a response. An example of background information is: “In the context of software security . . . ”
b) As a directive, The PES module may give the model a clear directive or action to perform based on the identified vulnerability. A directive example is “Analyze the following code snippet for vulnerabilities . . . ”
c) As main content, the PES module may include the specific data or content that the model needs to process or analyze. A main content example is “Here is the code snippet: [code].”
d) As boundaries, the PES module may provide additional instructions that modify or refine the main instruction, setting boundaries or specific criteria for the model's response. A boundary example is “Only use the provided solutions from the Security Solution Catalog.”
e) As sample inputs/outputs, the PES module may include sample inputs and outputs that demonstrate the desired behavior or format of the model's response. An example of sample inputs/outputs is “For example, if the vulnerability is X, the solution should be Y.”
f) As response structure, the PES module may specify the format in which the model's response should be structured, ensuring that the output meets the required criteria. An example of a response structure is “Provide the remediation in the unified diff format.”

At 710, the process may use the RGS to send optimized prompts to the LLM Suite Chat API to generate PR-ready code snippets.

At 712, the process may use the RGS to log the generated remediation recommendations for tracking and feedback purposes.

At 714, the process may use the RGS to also store the PR-ready remediation recommendations in the core services' internal databases.

At 716, in the process, developers may review the recommendations and apply the fixes. User feedback may be collected via subsequent commits of the same files.

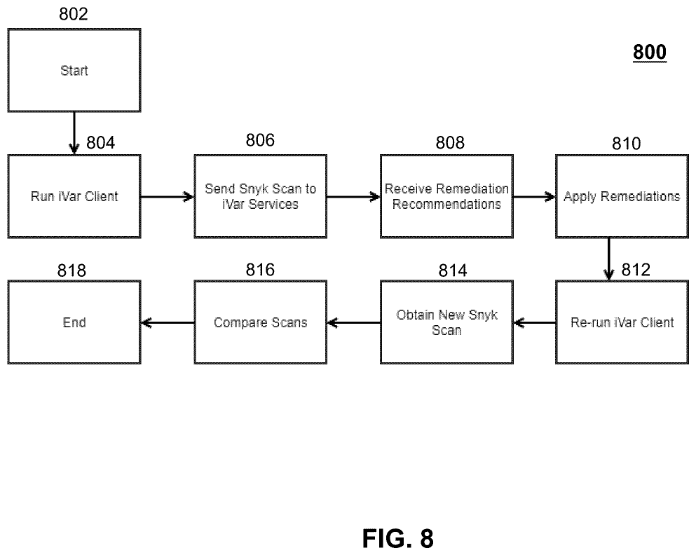

FIG. 8 illustrates an exemplary flow diagram of an iVar remediation auto-evaluation process 800 implemented by an iVar system in accordance with embodiments of the present disclosure. At 802, the process may start.

At 804, the process may run an iVar Client to execute the iVar client on representative vulnerability repositories to identify existing vulnerabilities.

At 806, the process may send SAST tool scan results. The SAST tool may submit the scan results to the iVar services for further analysis.

At 808, the process may receive the remediation recommendations to obtain the PR-ready remediation recommendations for identified vulnerabilities from the iVar services in the form of a unified diff.

At 810, the process may apply remediations. The process may use the unified diff as a guide to apply the recommended remediations to the repositories.

At 812, the process may re-run the iVar Client. The process may execute the iVar client on the remediated repositories to verify the applied changes.

At 814, the process may obtain new SAST tool scans. The process may perform a new SAST tool scan on the remediated repositories to identify any remaining or new vulnerabilities.

At 816, the process may compare scans. The process may compare the new SAST tool scan results with the previous scan results (before remediation) to evaluate the effectiveness of the applied remediations. At 818, the process may end.

The system and methods according to the present disclosure may provide several advantages. For example, the system and method may provide comprehensive indexing and cataloging of internally developed STK solutions, advanced engineering techniques via an LLM suite, and its ability to deliver detailed, context-aware vulnerability analysis and PR-ready remediation recommendations. Additionally, the iVar system may seamlessly integrate into various stages of the development workflow including pre-commit and post-commit stages, providing real-time feedback and actionable insights. The present disclosure may provide a holistic approach that ensures accurate, reliable, and highly relevant remediations tailored to specific organizational and regulatory contexts, significantly enhancing overall software security.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A computer-implemented method comprising:
receiving, at a vulnerability normalization service module, scan results of a source code that identifies a vulnerability in the source code and a scanning tool solution for the identified vulnerability;
extracting, implemented by the vulnerability normalization service module, from the scan results a minimum amount of vulnerable code snippet from an area in the source code that contains the identified vulnerability;
receiving, at a remediation generation service module from by the vulnerability normalization service module, the vulnerable code snippet;
generating, by the remediation generation service module, itemized code snippets from the vulnerable code snippet by assigning unique vulnerability identifications to each identified vulnerability;
generating, by the remediation generation service module, optimized prompts by:
implementing prompt engineering techniques to analyze context of the itemized code snippets and each identified vulnerability;
integrating solutions from a security solution catalog into the scanning tool solution based on the analyzed context, wherein the solutions include concise, prescriptive, and organization relevant solutions; and
integrating the solutions into the optimized prompts; and
sending, by the remediation generation service module, the optimized prompts to a large language model (LLM) to generate pull-request-ready (PR-ready) remediation recommendations for each identified vulnerabilities.

2. The method of claim 1, wherein receiving the scan results of the source code comprises receiving the scan results of the source code from a pre-commit process.

3. The method of claim 1, wherein receiving the scan results of the source code comprises receiving the scan results of the source code from a post-commit process.

4. The method of claim 1, wherein the vulnerable code snippet received at the remediation generation service module, comprises the vulnerable code snippets and metadata.

5. The method of claim 1, further comprising normalizing, by the vulnerability normalization service module, the scan results into a unified format.

6. The method of claim 1, further comprising, determining, by the vulnerability normalization service module, placement of the PR-ready remediation recommendations for each identified vulnerabilities based on a vulnerability source or a vulnerability sink depending on a vulnerability type.

7. The method of claim 1, wherein the security solution catalog includes usage descriptions for both internal STK (Security Tool Kit) solutions and industry-accepted third-party solutions.

8. The method of claim 1, wherein, the prompt engineering techniques include structured prompt recipes with well-defined ingredients.

9. The method of claim 1, wherein receiving the scan results operates a request-based mode or an event-based mode.

10. The method of claim 1, wherein the LLM comprises an LLM chatbot configured to understand context, handle complex questions, and engage in human-simulated conversation.

11. The method of claim 1, further comprising receiving the scan results in a cloud computing environment.

12. A system comprising:
a vulnerability normalization service module configured to receive scan results of a source code that identifies a vulnerability in the source code and a scanning tool solution for the identified vulnerability;
the vulnerability normalization service module configured to extract from the scan results a minimum amount of vulnerable code snippet from an area in the source code that contains the identified vulnerability;
a remediation generation service module configured to receive, from the vulnerability normalization service module, the vulnerable code snippet;
the remediation generation service module configured to:
generate itemized code snippets from the vulnerable code snippet by assigning unique vulnerability identifications to each identified vulnerability;
generate optimized prompts by implementing prompt engineering techniques to analyze context of the itemized code snippets and each identified vulnerability and integrating solutions from a security solution catalog into the scanning tool solution based on the analyzed context, wherein the solutions include concise, prescriptive, and organization relevant solutions; and
integrate the solutions into the optimized prompts; and
send the optimized prompts to a large language model (LLM) to generate pull-request-ready (PR-ready) remediation recommendations for each identified vulnerabilities.

13. The system of claim 12, wherein the vulnerability normalization service module is configured to receive the scan results of the source code from a pre-commit process.

14. The system of claim 12, wherein the vulnerability normalization service module is configured to receive the scan results of the source code from a post-commit process.

15. The system of claim 12, wherein the vulnerable code snippet received at the remediation generation service module, comprises the vulnerable code snippets and metadata.

16. The system of claim 12, wherein the vulnerability normalization service module is configured to normalize the scan results into a unified format.

17. The system of claim 12, the vulnerability normalization service module is configured to determine a placement of the PR-ready remediation recommendations for each identified vulnerabilities based on a vulnerability source or a vulnerability sink depending on a vulnerability type.

18. The system of claim 12, wherein the security solution catalog includes usage descriptions for both internal STK (Security Tool Kit) solutions and industry-accepted third-party solutions.

19. The system of claim 12, wherein, the prompt engineering techniques include structured prompt recipes with well-defined ingredients.

20. A computer-implemented method comprising:
receiving, at a vulnerability normalization service module, scan results of a source code that identifies a vulnerability in the source code and a scanning tool solution for the identified vulnerability;
extracting, implemented by the vulnerability normalization service module, from the scan results a minimum amount of vulnerable code snippet from an area in the source code that contains the identified vulnerability;
receiving, at a remediation generation service module from by the vulnerability normalization service module, the vulnerable code snippet;
generating, by the remediation generation service module, itemized code snippets from the vulnerable code snippet by assigning unique vulnerability identifications to each identified vulnerability;
generating, by the remediation generation service module, optimized prompts by:
implementing prompt engineering techniques to analyze context of the itemized code snippets and each identified vulnerability; and
integrating solutions from a security solution catalog into the scanning tool solution based on the analyzed context, wherein the solutions include concise, prescriptive, and organization relevant solutions; and
integrating the solutions into the optimized prompts; and
sending, by the remediation generation service module, the optimized prompts to a large language model (LLM) to generate pull-request-ready (PR-ready) remediation recommendations for each identified vulnerabilities.
